(19) United States
(12) Patent Application Publication
(10) Pub. No.: US 2026/0233189 A1
(43) Pub. Date: Aug. 13, 2026

(54) APPARATUS AND METHOD FOR GAS FLOW CARBONIZATION OF ENERGETIC MATERIALS

(71) Applicant: RIKOMAY RECYCLING SINGAPORE PTE. LTD., Singapore (SG)

(72) Inventors: Zhiming ZHOU, Wuhan (CN); Yuancheng CAO, Wuhan (CN); Jianfeng ZHANG, Wuhan (CN); Xiuye WANG, Wuhan (CN)

(21) Appl. No.: 19/639,153

(22) Filed: Apr. 4, 2026

(30) Foreign Application Priority Data
Sep. 23, 2025 (CN) 202511361900.3

(51) Int. Cl. B01J 19/20; B01J 19/02; H01M 6/52; H01M 10/54

(52) U.S. Cl. CPC B01J 19/20; B01J 19/02; H01M 6/52; H01M 10/54; B01J 2219/00123; B01J 2219/00164

(57) ABSTRACT

An apparatus for gas flow carbonization of energetic materials, including a screw conveyor and a heater. The screw conveyor includes an outer cylinder and a screw shaft. The outer cylinder is provided with a feeding port, a discharge port, a gas inlet and a gas outlet. The gas inlet and the gas outlet are each provided with a valve. The heater is configured to heat and supply inert gas to the gas inlet. A gas-flow carbonization method is also provided. After heating the inert gas to a required temperature, the discharge port is closed and the feeding port is opened. The heated inert gas is transported into the outer cylinder to maintain an oxygen volume concentration below 2%. After the to-be-treated material is inputted into the outer cylinder, the valve of the feeding port is closed.

### CROSS-REFERENCE TO RELATED APPLICATIONS

This application claims the benefit of priority from Chinese Patent Application No. 202511361900.3, filed on September 23, 2025. The content of the aforementioned application, including any intervening amendments thereto, is incorporated herein by reference in its entirety.

### TECHNICAL FIELD

This application relates to carbonization techniques, and more particularly to an apparatus and method for gas flow carbonization of energetic materials.

### BACKGROUND

With the rapid development of the new energy automobile industry, a large number of power batteries have entered the retirement phase. Efficient and environmentally-friendly recycling of these batteries is essential for resource sustainability and environmental protection. Due to the presence of valuable metals including lithium, cobalt, nickel and manganese, the positive electrode materials are considered as the recycling core of retired power batterie. The negative electrode is usually made of a graphite material and a copper foil current collector through an organic binder. To achieve complete separation of various components within the battery cell, high-temperature carbonization technology is often introduced as an efficient pretreatment process. This process leverages the thermal decomposition of organic substances under oxygen-deficient and high-temperature conditions, allowing organic components, such as binders, separators and electrolytes, to be fully decomposed into volatile gases and residual carbon.

The current mainstream carbonization process is time-consuming (generally more than 90 min), and typically employs a rotary kiln as the carbonization equipment, which results in large space occupation and high energy consumption.

### SUMMARY

An object of the present disclosure is to provide an apparatus and method for gas flow carbonization of energetic materials, so as to address the above technical problems.

The present disclosure adopts the following technical solutions.

An apparatus for gas flow carbonization of energetic materials, comprising:

a screw conveyor; and

a heater;

wherein the screw conveyor comprises an outer cylinder and a screw shaft arranged inside the outer cylinder; a feeding port is arranged at an upper side of a first end of the outer cylinder; a discharge port is arranged at a lower side of a second end of the outer cylinder; the feeding port and the discharge port are each provided with a valve; the outer cylinder is provided with at least one gas inlet and a gas outlet; and

the heater communicates with the at least one gas inlet, and is configured to heat an inert gas and supply heated inert gas to the at least one gas inlet.

The present disclosure has the following beneficial effects.

High-purity inert gas serves as the heat transfer medium to prevent material oxidation during carbonization. This apparatus controls oxygen concentration inside the outer cylinder and increases the contact surface area between the materials and heat source.

By means of this, it ensures uniform and complete carbonization, improves thermal efficiency, and effectively reduces energy consumption. The screw conveyor and the heater adopt a split-type design, enabling flexible production line layout and higher space utilization. Compared to other carbonization apparatuses, this apparatus provided herein features a simple structure, lower manufacturing cost and favorable economic benefits.

Based on the above arrangements, the present disclosure has the following improvements.

In some embodiments, the at least one gas inlet is arranged between the feeding port and the discharge port; and the gas outlet is arranged between the feeding port and the discharge port.

In some embodiments, the outer cylinder is provided with a plurality of gas inlets; and the plurality of gas inlets are respectively arranged at different positions of the outer cylinder, and are connected to the heater.

By setting the plurality of gas inlets, the apparatus ensures a uniform temperature therein and prevents local temperatures from being too low, thus avoiding the failure to reach the required temperature for carbonization.

In some embodiments, the at least one gas inlet and the gas outlet are each provided with a temperature sensor.

By setting the temperature sensor, the apparatus monitors a carbonization temperature in real time and adjusts parameters such as a gas flow rate and heater power through temperature feedback to ensure the required temperature for material carbonization.

In some embodiments, the at least one gas inlet is provided with a gas flow control valve; and the heater is configured to heat the inert gas, and supply the heated inert gas to the at least one gas inlet through the gas flow control valve.

By setting the gas flow control valve, the apparatus adjusts the gas flow rate to reduce temperature fluctuations inside the outer cylinder.

In some embodiments, a thermal-insulation layer is arranged outside the outer cylinder, and is configured to wrap the outer cylinder.

By setting the thermal-insulation layer, the apparatus has low heat loss and energy consumption.

In some embodiments, the thermal-insulation layer is made of a ceramic fiber, which effectively control oxygen concentration inside the outer cylinder.

In some embodiments, the outer cylinder and the screw shaft are made of heat-resisting stainless steel, which features high-temperature resistance and corrosion-resistance.

In some embodiments, the present disclosure provides a method for gas flow carbonization of energetic materials, the method being performed using the aforementioned apparatus, and the method comprising:

heating, by the heater, the inert gas to a required temperature for material carbonization;

closing the valve of the discharge port, and opening the valve of the feeding port;

transporting the heated inert gas into the outer cylinder through the at least one gas inlet, so as to maintain an oxygen volume concentration inside the outer cylinder below 2%; and

feeding the energetic materials into the outer cylinder and closing the valve of the feeding port; and continuously supplying the heated inert gas to heat the energetic materials inside the outer cylinder for carbonization;

wherein the energetic materials are shredded battery cell material.

By employing high-purity inert gas as the heat source medium, it can not only control the oxygen concentration inside the outer cylinder, but also increase the surface area of contact between the energetic materials and the heat source. The energetic materials will be carbonized evenly and fully, with higher thermal efficiency, effectively reducing energy consumption, more flexible production line layout and higher space utilization.

### BRIEF DESCRIPTION OF THE DRAWINGS

FIG. 1 schematically shows an apparatus for gas flow carbonization of energetic materials according to an embodiment of the present disclosure.

In the figure: 1-screw conveyor; 110-outer cylinder; 111-feeding port; 112-discharge port; 113-gas inlet; 114-gas outlet; 120-motor; 2-heater; 3-valve; 4-temperature sensor; 5-gas flow control valve; and 6-thermal-insulation layer.

### DETAILED DESCRIPTION OF EMBODIMENTS

The technical principles and features of the present disclosure will be described in combination with the accompanying figures. The embodiments are merely illustrative, and not intended to limit this present disclosure.

### EMBODIMENT 1

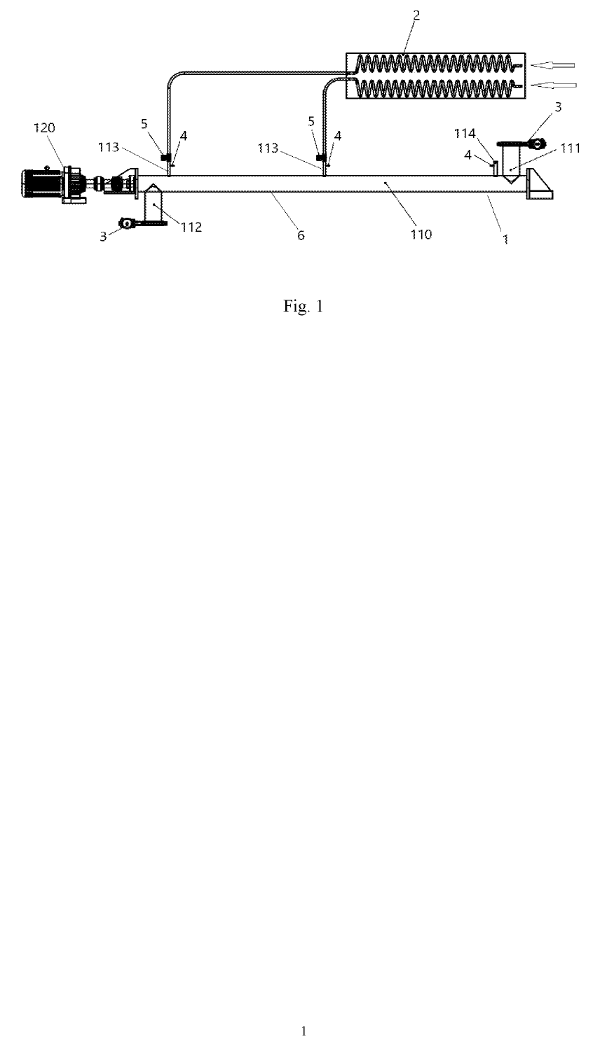

Referring to FIG. 1, the present disclosure provides an apparatus for gas flow carbonization of energetic materials. The apparatus includes a screw conveyor 1 and a heater 2. The screw conveyor 1 includes an outer cylinder 110 and a screw shaft arranged inside the outer cylinder 110. A feeding port 111 is arrange at an upper side of a first end of the outer cylinder 110. A discharge port 112 is arranged at a lower side of a second end of the outer cylinder 110.

The screw conveyor 1 further includes a motor 120 arranged outside the outer cylinder 110. Two ends of the outer cylinder 110 are sealed. An end of the screw shaft is configured to pass through the outer cylinder 110, a coupler and a speed reducer in sequence, and then connected to a main shaft of the motor 120. The feeding port 111 is provided with a valve 3. The valve 3 of the feeding port 111 is configured to close and open the feeding port 111. The discharge port 112 is provided with a valve 3. The valve 3 of the discharge port 112 is configured to close and open the discharge port 112. The outer cylinder 110 is provided with at least one gas inlet 113 and a gas outlet 114. The heater 2 communicates with the at least one gas inlet 113, and is configured to heat an inert gas and supply heated inert gas to the at least one gas inlet 113. The heated inert gas is sequentially fed into the outer cylinder 110. Tail gas from the outer cylinder 110 is discharged through the gas outlet 114.

The present disclosure provides a method for gas flow carbonization of energetic materials. The method is performed using the aforementioned apparatus. The method is performed through the following steps.

The heater 2 is configured to heat the inert gas to a required temperature for material carbonization. The valve 3 of the discharge port 112 is closed, and the valve 3 of the feeding port 111 is opened. The heated inert gas is transported into the outer cylinder 110 through the at least one gas inlet 113, so as to maintain an oxygen volume concentration inside the outer cylinder 110 below 2%. The energetic materials are fed into the outer cylinder 110, and the valve 3 of the feeding port 111 is closed. The heated inert gas is continuously supplied to heat the energetic materials inside the outer cylinder 110 for carbonization. The energetic materials are shredded battery cell material, including a positive electrode plate, a negative electrode plate, a separator, a casing and an electrolyte. The screw shaft is configured to rotate to allow the energetic materials to move inside the outer cylinder 110. A rotating speed of the screw shaft is controlled to satisfy a required time for material carbonization.

High-purity inert gas serves as the heat transfer medium to prevent material oxidation during carbonization. This apparatus controls the oxygen concentration inside the outer cylinder 110 and increases the contact surface area between the materials and heat source. By means of this, it ensures uniform and complete carbonization, improves thermal efficiency, and effectively reduces energy consumption.

The screw conveyor 1 and the heater 2 adopt a split-type design, enabling flexible production line layout and higher space utilization.

Compared to other carbonization apparatuses, this apparatus provided herein features a simple structure, lower manufacturing cost and favorable economic benefits.

### EMBODIMENT 2

Referring to FIG. 1, this embodiment has the following improvements based on Embodiment 1.

The at least one gas inlet 113 is arranged between the feeding port 111 and the discharge port 112. The gas outlet 114 is arranged between the feeding port 111 and the discharge port 112, preferably, adjacent to the feeding port 111.

### EMBODIMENT 3

Referring to FIG. 1, this embodiment has the following improvements based on Embodiment 1 and Embodiment 2.

The outer cylinder 110 is provided with a plurality of gas inlets 113. The plurality of gas inlets 113 are respectively arranged at different positions of the outer cylinder 110, and are connected to the heater 2, preferably, at a middle of the outer cylinder 110 and adjacent to the feeding port 112.

By setting the plurality of gas inlets 113, this apparatus ensures a uniform internal temperature and prevents local temperatures from being too low, thus avoiding the failure to reach the required temperature for carbonization.

### EMBODIMENT 4

Referring to FIG. 1, this embodiment has the following improvements based on Embodiments 1-3.

The at least one gas inlet 113 and the gas outlet 114 are each provided with a temperature sensor 4.

By setting the temperature sensors 4, the apparatus monitors a carbonization temperature in real time and adjusts parameters such as a gas flow rate and a heater power of the heater 2 through temperature feedback to ensure the required temperature for material carbonization.

In some embodiments, the at least one gas inlet 113 is provided with a gas flow control valve 5. The heater 2 is configured to heat the inert gas and supply the heated inert gas to the at least one gas inlet 113 through the gas flow control valve 5.

By setting the gas flow control valve 5, the apparatus adjusts the gas flow rate to reduce temperature fluctuations inside the outer cylinder 110.

### EMBODIMENT 5

Referring to FIG. 1, this embodiment has the following improvements based on Embodiments 1-4.

A thermal-insulation layer 6 is arranged outside the outer cylinder 110, and is configured to wrap the outer cylinder 110 to enable low heat loss and energy consumption. The thermal-insulation layer 6 is made of a ceramic fiber.

### EMBODIMENT 6

Referring to FIG. 1, this embodiment has the following improvements based on Embodiments 1-5.

The outer cylinder 110 and the screw shaft are each made of heat-resisting stainless steel, such as 310 stainless steel, so as to achieve high-temperature resistance and corrosion-resistance.

### EMBODIMENT 7

Referring to FIG. 1, this embodiment has the following improvements based on Embodiments 1-6.

The heater 2 includes a heating chamber. The heating chamber is provided with at least one helical heating tube. The at least one helical heating tube is connected to the at least one gas inlet 113 on the outer cylinder 110 through a gas conduit. The inert gas enters the at least one helical heating tube, flows towards the gas conduit after heating, and finally enters the outer cylinder 110 through the at least one gas inlet 113. Tail gas from a tail gas system is introduced into the heating chamber, serving as the heating source, so as to heat the inert gas inside the at least one helical heating tube. The thermal-insulated layer 6 is arranged outside the heating chamber, and is configured to wrap the heating chamber, so as to enable low energy loss and energy consumption. The at least one helical tube is configured to communicate with the at least one gas inlet 113 through the gas conduit, so as to control gas flow rate of the at least one gas inlet 113, thereby controlling temperatures of the different positions inside the outer cylinder 110.

The heater 2 can also employ other heating ways. For example, the heater 2 is configured as an electric heater. It should be noted that the electric heater is exemplary, and not intended to limit the heater 2.

Although the present disclosure has been described above with reference to the embodiments, it can be understood that these embodiments are merely exemplary and cannot be understood as limitations of the present disclosure. It should be noted that any changes, improvements, replacements and modifications made by those skilled in the art without departing from the spirit of the disclosure shall fall within the scope of the disclosure defined by the appended claims.

What is claimed is:

1. An apparatus for gas flow carbonization of energetic materials, comprising a screw conveyor; and a heater; wherein the screw conveyor comprises an outer cylinder and a screw shaft arranged inside the outer cylinder; a feeding port is arranged at an upper side of a first end of the outer cylinder; a discharge port is arranged at a lower side of a second end of the outer cylinder; the feeding port and the discharge port are each provided with a valve; the outer cylinder is provided with at least one gas inlet and a gas outlet; and the heater communicates with the at least one gas inlet, and is configured to heat an inert gas and supply heated inert gas to the at least one gas inlet.

2. The apparatus of claim 1, wherein the at least one gas inlet is arranged between the feeding port and the discharge port; and the gas outlet is arranged between the feeding port and the discharge port.

3. The apparatus of claim 1, wherein the outer cylinder is provided with a plurality of gas inlets; and the plurality of gas inlets are respectively arranged at different positions of the outer cylinder, and are connected to the heater.

4. The apparatus of claim 1, wherein the at least one gas inlet and the gas outlet are each provided with a temperature sensor.

5. The apparatus of claim 4, wherein the at least one gas inlet is provided with a gas flow control valve; and the heater is configured to heat the inert gas, and supply the heated inert gas to the at least one gas inlet through the gas flow control valve.

6. The apparatus of claim 1, wherein a thermal-insulation layer is arranged outside the outer cylinder, and is configured to wrap the outer cylinder.

7. The apparatus of claim 6, wherein the thermal-insulation layer is made of a ceramic fiber.

8. The apparatus of claim 1, wherein the outer cylinder and the screw shaft are made of stainless steel.

9. A method for gas flow carbonization of energetic materials, the method being performed using the apparatus of claim 1, and the method comprising: heating, by the heater, the inert gas to a required temperature for material carbonization; closing the valve of the discharge port, and opening the valve of the feeding port; transporting the heated inert gas into the outer cylinder through the at least one gas inlet, so as to maintain an oxygen volume concentration inside the outer cylinder below 2%; and feeding the energetic materials into the outer cylinder, and closing the valve of the feeding port; and continuously supplying the heated inert gas to heat the energetic materials inside the outer cylinder for carbonization;
wherein the energetic materials are shredded battery cell materials.
